(19) United States
(12) Patent Application Publication
(10) Pub. No.: US 2025/0342183 A1
(43) Pub. Date: Nov. 6, 2025

(54) USING SHAPLEY VALUES TO EVALUATE PROMPT GENERATION PARAMETERS

(71) Applicant: ADOBE INC., San Jose, CA (US)

(72) Inventors: Shankar VENKITACHALAM, Fremont, CA (US); Meghanath M Y, San Jose, CA (US); Deepak PAI, Sunnyvale, CA (US); Debraj Debashish BASU, Sunnyvale, CA (US); Anish NARANG, San Francisco, CA (US)

(21) Appl. No.: 18/655,047

(22) Filed: May 3, 2024

(51) Int. Cl. G06F 16/332; G06F 40/253

(52) U.S. Cl. CPC G06F 16/3329; G06F 40/253

(57) ABSTRACT

Methods and systems are provided for using Shapley values to evaluate prompt generation parameters. In embodiments described herein, a selection of prompt parameters are accessed. A plurality of prompts are generated as a function of a combination of the prompt parameters. A corresponding quality metric is determined for each of the prompts. Prompt parameter contribution metrics are determined using a Shapley-value-based determination corresponding to a contribution of each of the prompt parameters to the corresponding content quality metric for each of the prompts. The prompt parameter contribution metrics are then displayed.

### BACKGROUND

Language models, such as large language models (LLMs), are often utilized by businesses to generate high-quality, consistent, and on-brand content for marketing purposes and to engage with customers. A prompt is the input text (and/or other multimedia, such as images) that guides the response generation from the language model. In this regard, prompts play a significant role in enabling a language model to produce a desired output to ensure that the desired output meets the specific guidelines of the business, such as the tone desired by the business, quality metrics (e.g., search engine optimization (SEO), readability, and originality), and/or others.

### SUMMARY

Various aspects of the technology described herein are generally directed to systems, methods, and computer storage media for, among other things, using Shapley values to evaluate prompt generation parameters. In this regard, embodiments described herein facilitate the automated use of Shapley values to evaluate prompt generation parameters in order to determine the contribution of prompt parameters to content quality metrics. For example, a user selects and/or inputs prompt parameters, such as data in contextual input fields to provide context to the language model in generating the content and/or prompt refinement tools to generate and/or refine a prompt. Prompts are generated based on applying combinations of the prompt parameters where the combinations of prompt parameters are determined using a Shapley-value-based determination. Content quality metrics are determined for each of the prompts generated based on combinations of prompt parameters. Prompt parameter contribution metrics corresponding to a contribution of each of the prompt parameters to the corresponding content quality metrics (e.g., determined for each of the prompts generated based on combinations of prompt parameters) are determined for each of the prompt parameters using the Shapley-value-based determination. A representation of the prompt parameter contribution metrics, such as the values of the prompt parameter contribution metrics or a graph of the prompt parameter contribution metrics, can be displayed to user via a user interface component.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3A provides an example diagram of using Shapley values to evaluate prompt generation parameters, in accordance with embodiments of the present disclosure.

FIG. 3B provides an example diagram of prompt parameter contribution metrics, in accordance with embodiments of the present disclosure.

FIG. 4 is a process flow showing a method for using Shapley values to evaluate prompt generation parameters, in accordance with embodiments of the present disclosure.

FIG. 5 is a block diagram of an example computing device in which embodiments of the present disclosure can be employed.

### DETAILED DESCRIPTION

### Definitions

Various terms are used throughout the description of embodiments provided herein. A brief overview of such terms and phrases is provided here for ease of understanding, but more details of these terms and phrases is provided throughout.

A “language model” generally refers to an artificial intelligence (AI) system trained to understand and generate content, such as human-readable text and/or other multimedia, such as images, based on an input prompt.

A “prompt template” generally refers to a structured guide to help in generating a specific prompt to a language model. For example, a prompt template can include contextual input fields that the user can fill out to customize the prompt to the language model to generate content. A specific example of a prompt can include:

### Prompt Template

You are a helpful, respectful and honest assistant that generates marketing content that adheres to brand guidelines given below:
Brand summary: {brand_summary}
Campaign Characteristics:
SEO keywords: {seo_keywords}
Overview of the Campaign: {campaign_overview}
Competitive Landscape: {competitive_landscape}
Intended Campaign Audience: {campaign_audience}
Call to Actions: {call_to_action}
Intended KPI: {kpi}
Intended Objective: {objective}
Tone of Voice: {tone_voice}
Geography: {geo_name}
Related Marketing Channels: {channel_name}
Related Products: {product name}
Base Prompt Instruction {base_instruction}

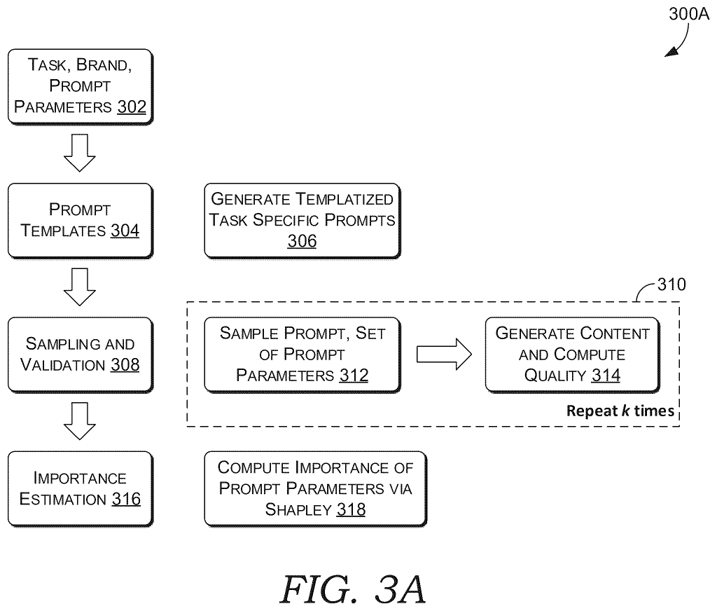

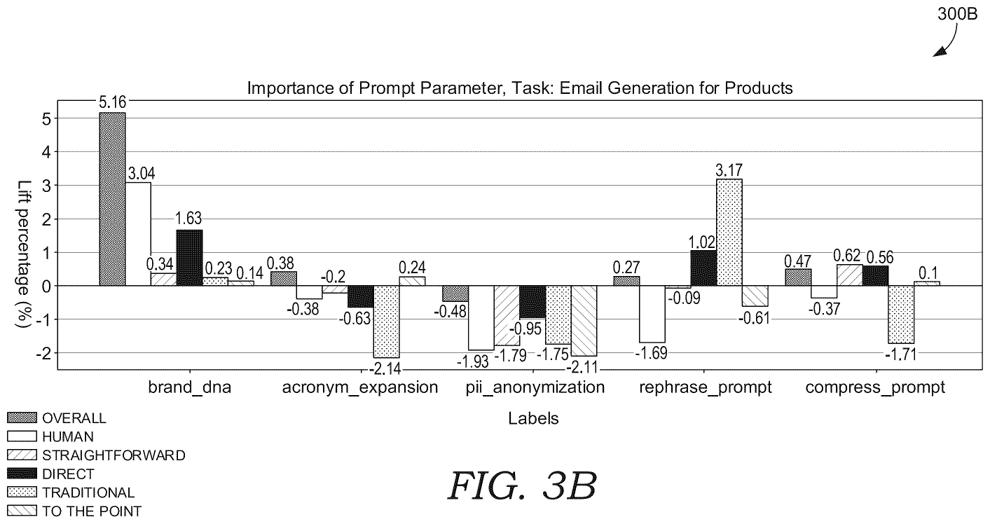

“Prompt parameters” (also referred to herein as “prompt generation parameters”) generally refers to various types of contextual input fields and/or prompt refinement tools that can be utilized to generate a prompt for a language model. As shown in the example of FIG. 3B, prompt parameter contribution metrics can be determined for each of the prompt parameters that are used to generate a prompt so that a user can assess each of the prompt parameters, in accordance with embodiments of the present disclosure.

“Contextual input fields” generally refers to data provided by the user regarding the specific task to provide context to the language model in generating the content. For example, with respect to the specific example above, each of the contextual input fields (e.g., {brand_summary}, {seo_keywords}, etc.) is a corresponding prompt parameter that can be provided by the user to provide context to the language model in generating the content. In some embodiments, each contextual input field (e.g., in a prompt template) can correspond to a separate prompt parameter in order to determine a prompt parameter contribution metric (e.g., with respect to each content quality metric) for each of the contextual input fields so that a user can assess the performance of each of the contextual input fields. An example of determining prompt parameter contribution metrics for a contextual input field (e.g., brand_dna) is shown in FIG. 3B.

“Prompt refinement tools” generally refers to any tool that can be utilized to generate and/or refine a prompt, such as any tool implemented to improve prompts to elicit better responses from a language model and/or optimize token costs of the prompt. Examples of prompt refinement tools include a prompt rephrasing tool, a prompt compression tool, an acronym expander tool, a personal identifiable information (PII) removal tool, a language model selection tool, and/or any tool that can be utilized to generate and/or refine the prompt. In some embodiments, each prompt refinement tool can correspond to a separate prompt parameter in order to determine a prompt parameter contribution metric (e.g., with respect to each content quality metric) for each of the prompt refinement tools so that a user can assess each of the prompt refinement tools. An example of determining prompt parameter contribution metrics for prompt refinement tools (e.g., rephrase_prompt, compress_prompt, acronym_expansion, and pii_anonymization) is shown in FIG. 3B.

A “prompt rephrasing tool” generally refers to a prompt refinement tool that utilizes a model to rephrase a prompt for a specific task. For example, a prompt rephrasing tool may rephrase a prompt for coherence and/or to add relevant details. As another example, a prompt rephrasing tool may rephrase a prompt, or a portion thereof into bullet point from block text or from bullet points to block text. Any known technique, such as natural language processing techniques, optimization techniques, etc., can be implemented by the prompt rephrasing tool.

A “prompt compression tool” generally refers to a prompt refinement tool that utilizes a model to paraphrase a prompt to more concise lengths without changing the meaning of the prompt (e.g., by removing unnecessary words or letters, rephrasing synonyms, etc.) in order to reduce the token size of the prompt (e.g., thereby reducing the token cost to prompt the language model). For example, a prompt compression tool can be a model that is trained for prompt optimization through text compression using the measured quality (e.g., cosine similarity between the Sentence-Bidirectional Encoder Representations from Transformers (SBERT) generated embeddings) of the reduced prompt and original prompt to reduce token count, but maintain the quality of the prompt. Any known technique, such as natural language processing techniques, optimization techniques, etc., can be implemented by the prompt compression tool.

An “acronym expander tool” generally refers to a prompt refinement tool that utilizes a model to expand acronyms in a prompt. For example, the model can be trained to determine the correct acronym expansion based on the context of the prompt (e.g., “AI” could refer to “Adobe Illustrator” or “Artificial Intelligence”). Any known technique, such as natural language processing techniques, optimization techniques, etc., can be implemented by the acronym expander tool.

A “PII removal tool” generally refers to a prompt refinement tool that utilizes a model to remove PII from a prompt (e.g., such as by anonymizing the PII, deleting the PII, etc.). For example, PII refers to any data that could potentially identify a specific individual or company, such as a name, location, social security numbers, e-mail addresses, phone numbers, and/or others. As a specific example, a PII removal tool can be implemented in order to scrub company names from customer success stories documents prior to passing them into the prompt. In some embodiments, a PII removal can include various settings based on the type of PII that a company decides to remove from a prompt. Any known technique, such as natural language processing techniques, optimization techniques, etc., can be implemented by the PII removal tool.

A “language model selection tool” generally refers to a tool that utilizes a model to determine a language model to apply a prompt in order to optimize cost and quality of the output content based on the input prompt. Any known technique, such as natural language processing techniques, optimization techniques, etc., can be implemented by the language model selection tool.

A “content quality metric” generally refers to a quality measure of content generated by a language model based on an input prompt and/or the input prompt itself with respect to a corresponding dimension. In some embodiments, each content quality metric corresponds to a corresponding stylistic dimension. A “stylistic dimension” generally refers to a dimension related to whether content meets a specific style, such as a score whether the content is in overall alignment with a business's branding guidelines, formal, corny, ambiguous, arrogant, aggressive, elitist, traditional, mundane, antagonistic, political, literal, tactical, emulating others, chasing trends, derivative, engaging, human, emotional, creative, thought provoking, directional, informational, conversational, straightforward, to the point, punchy, direct, really long, any other stylistic dimensions, and/or any combination thereof. In this regard, a set of content quality metrics can be determined for each stylistic dimension (e.g., a score whether the content is in overall alignment with a business's branding guidelines, a score whether the content is formal, etc.) and/or each error measure for a prompt and/or generated content (e.g., such as content generated by a language model and/or an input prompt) to provide a score indicating how well the prompt and/or generated content adheres to each corresponding stylistic dimension and/or each error measure. In some embodiments, each content quality metric can be determined based on a brand alignment model that evaluates how well a given prompt and/or generated content aligns with the branding guidelines of a particular business. For example, given a text document of generated content, a brand alignment model determines a score (e.g., between 0 and 1) indicating how well the text document aligns with the overall style of the business and scores for each of the various stylistic dimensions defining the branding style, voice, tone, etc. of the business. In this regard, the brand alignment model provides insights into how well the text conforms to brand guidelines, while also identifying specific areas of improvement. In some embodiments, the brand alignment model utilizes a language model, such as an LLM, to determine a score for each stylistic dimension. In some embodiments, content quality can be determined with respect to any known error measure, such as accuracy, and/or other evaluation metric.

“Prompt parameter contribution metric” generally refers to a quality measure (e.g., importance) of the contribution of each prompt parameter with respect to each content quality metric. For example, each prompt parameter can be scored with respect to each content quality metric using a Shapley-value-based determination based on the contribution of each prompt parameter. A “Shapley-value-based determination” generally refers to Shapley value computations, Shapley value approximation methods (e.g., any known approximation technique, such as a Monte Carlo estimate), lift percentage determined based on Shapley value computations or Shapley value approximation methods, and/or any determination that utilizes Shapley value. “Lift percentage” generally refers to a quantifiable measure of the additional value or performance gained by taking a specific action with respect to a baseline. An example of prompt parameter contribution metrics with respect to a set of stylistic dimensions of content quality metrics (e.g., overall alignment with a business's branding guidelines, human, straightforward, direct, traditional, and to the point) is shown in FIG. 3B.

### Overview

Language models, such as LLMs, are often utilized by businesses to generate high-quality, consistent, and on-brand content for marketing purposes and to engage with customers. A prompt is the input text (and/or other multimedia, such as images) that guides the response generation from the language model. In this regard, prompts play a significant role in enabling a language model to produce a desired output to ensure that the desired output meets the specific guidelines of the business, such as the tone desired by the business, quality metrics (e.g., SEO, readability, and originality), and/or others.

A user (e.g., such as a user implementing prompts to generate content on behalf of a business) has a significant amount of choices in implementing prompt parameters to generate a prompt in order to generate content via a language model. For example, a user can enter any amount of data in any amount of possible contextual input fields and a user can select from any number of prompt refinement tools to generate and/or refine a prompt.

While prior techniques exist to optimize prompts, prior techniques optimize prompts as a whole without any capability to assess the effectiveness of various prompt parameters (e.g., various contextual input fields, various prompt refinement tools, etc.) that a user can implement. For example, one prior technique utilizes user examples and gradient descent to determine the highest scoring prompt. Another prior technique utilizes reinforcement learning techniques to determine the highest scoring prompt based on feedback data. Thus, while prior techniques can determine a highest scoring prompt, the user is unable to evaluate the contribution of various prompt parameters (e.g., contextual input fields, prompt refinement tools, etc.) in order for the user to make decisions regarding the various prompt parameters. For example, a user may utilize the contribution of a specific prompt parameter (e.g., the prompt parameter contribution metric) to evaluate whether an increase in a content quality metric justifies the cost to implement the specific prompt parameter. As another example, a user may utilize the contribution of a specific prompt parameter (e.g., the prompt parameter contribution metric) to evaluate whether an issue with the specific prompt parameter is causing a decrease in a content quality metric (e.g., an acronym expander tool is identifying the wrong acronym expansion, a PH removal tool is removing too much information, etc.). The user can then fix the issue (e.g., by changing the settings of the acronym expander tool or PH removal tool, etc.) or choose not to implement the specific prompt parameter.

Currently, in order to evaluate various prompt parameters utilized for prompt generation, a programmer must manually perform random trial and error with the various prompt parameters by manually implementing each prompt parameter to generate a prompt, manually calling the LLM, manually reviewing the content generated by the LLM based on each prompt, and manually performing a subjective assessment of the various prompt parameters. In this regard, the process of manually performing random trial and error with the various prompt parameters is a manual intensive process. However, even if the programmer manually performs random trial and error with the various prompt parameters, the programmer will be unable to determine the effect of various combinations of parameters and/or different scenarios due to the time, costs, and computing resources required. Further, no objective metrics can be determined for the various prompt parameters by manually performing a subjective assessment of the various prompt parameters. In this regard, the manually intensive and computationally expensive process of manually performing random trial and error with the various prompt parameters will not provide accurate results and unnecessarily consume computing resources.

Accordingly, unnecessary computing resources are utilized by programmers to manually implement and evaluate prompt parameters in conventional implementations. For example, computing and network resources are unnecessarily consumed to facilitate the manual intensive process to manually perform random trial and error with the various prompt parameters by manually implementing each prompt parameter to generate a prompt, manually calling the LLM, manually reviewing the content generated by the LLM based on each prompt, and manually performing a subjective assessment of the various prompt parameters, such as by unnecessarily increasing computer input/output operations and computational expenses. Further, when the information related to manually performing random trial and error with the various prompt parameters is located in a disk array, there is unnecessary wear placed on the read/write head of the disk of the disk array each time the information is accessed. Even further, the processing of operations to manually perform random trial and error with the various prompt parameters decreases the throughput for a network, increases the network latency, and increases packet generation costs when the information is located over a network. However, even when unnecessary computing resources are utilized by programmers to manually perform random trial and error with the various prompt parameters in conventional implementations, the programmer will be unable to determine (1) the effect of various combinations of parameters and/or (2) objective metrics based on manually performing a subjective assessment of the various prompt parameters.

As such, embodiments of the present disclosure are directed to the automated use of Shapley values to evaluate prompt generation parameters in an efficient and effective manner. In this regard, the contribution of various prompt parameters to content quality metrics can be efficiently and effectively determined in an automated manner in order to provide prompt parameter contribution metrics to a user so that the user can utilize the prompt parameter contribution metrics to make decisions regarding the implementation of prompt parameters.

Generally, and at a high level, embodiments described herein facilitate the automated use of Shapley values to evaluate prompt generation parameters in order to determine the contribution of prompt parameters to content quality metrics. For example, a user selects and/or inputs prompt parameters, such as data in contextual input fields to provide context to the language model in generating the content and/or prompt refinement tools to generate and/or refine a prompt. Prompts are generated based on applying combinations of the prompt parameters where the combinations of prompt parameters are determined using a Shapley-value-based determination. Content quality metrics are determined for each of the prompts generated based on combinations of prompt parameters. Prompt parameter contribution metrics corresponding to a contribution of each of the prompt parameters to the corresponding content quality metrics (e.g., determined for each of the prompts generated based on combinations of prompt parameters) are determined for each of the prompt parameters using the Shapley-value-based determination. A representation of the prompt parameter contribution metrics, such as the values of the prompt parameter contribution metrics or a graph of the prompt parameter contribution metrics, can be displayed to user via a user interface component.

In operation, as described herein, a user selects and/or inputs prompt parameters. In some embodiments, a user can select and/or input data in contextual input fields to provide context to the language model in generating the content. For example, the contextual input fields can be designated fields in a prompt template. In some embodiments, a user can select prompt refinement tools to apply to the prompt. Examples of prompt refinement tools include a prompt rephrasing tool, a prompt compression tool, an acronym expander tool, a PII removal tool, a language model selection tool, and/or any tool that can be utilized to generate and/or refine the prompt (e.g., any tool implemented to improve prompts, such as by eliciting better responses from a language model and/or optimizing token costs of the prompt).

A Shapley-value-based determination is used to determine combinations of the prompt parameters to be used to compute prompt parameter contribution metrics for each of the prompt parameters. Prompts are generated based on applying the combinations of the prompt parameters to a prompt template. For example, for a prompt with parameters [A, B, C], there are six possible combinations: [A], [B], [C], [A, B], [B, C], [A, B, C] that can be utilized to generate six possible prompts using a prompt template. In this example, the six possible combinations of prompt parameters that can be used to generate corresponding prompts include (1) a prompt generated based on prompt parameter [A], where prompt parameters [B] and [C] are absent; (2) a prompt generated based on prompt parameter [B], where prompt parameters [A] and [C] are absent; (3) a prompt generated based on prompt parameter [C], where prompt parameters [A] and [B] are absent; (4) a prompt generated based on prompt parameters [A] and [B], where prompt parameter [C] is absent; (5) a prompt generated based on prompt parameters [B] and [C], where prompt parameter [A] is absent; and (6) a prompt generated based on prompt parameters [A], [B], and [C].

In this regard, the Shapley-value based determination is used to determine the number of combinations and/or the prompt parameters included in each combination. Examples of using the Shapley-value based determination are described in more detail with respect to FIG. 3A. In some embodiments, a sampling method for Shapley approximation can be utilized (e.g., by computing a Monte Carlo estimate for the Shapley value obtained by sampling from a uniform distribution of all permutations of the prompt parameters) in order to determine the number of combinations and the prompt parameters included in each combination. Any known Shapley value approximation methods (e.g., any known approximation technique, such as a Monte Carlo estimate) can be used to determine the number of combinations and/or the prompt parameters included in each combination.

In some embodiments, subsets of combinations of prompt parameters are applied to the prompt template in order to generate the plurality of prompts. In some embodiments, a user can select which prompt parameters to generate prompt parameter contribution metrics. For example, the user may only want to view prompt parameter contribution metrics for prompt refinement tools. In this regard, in some embodiments, a subset of the prompt parameters may be included in every combination in generating prompt. For example, if a user only selects to only view prompt parameter contribution metrics for prompt refinement tools or a specific contextual input field, the remaining prompt parameters can be included in every combination of prompt parameters.

In some embodiments, an instruction for a base prompt (e.g., a base prompt instruction), such as a designated task, is included in every combination to avoid evaluation of the base prompt. For example, a user designates a task of a base prompt of a prompt template, such as an instruction to introduce a particular product line. The user evaluates the contribution of each of the selected prompt parameters with respect to a prompt generated based on the base prompt instruction of the prompt template alone (e.g., without any of the prompt parameters that are being evaluated), in accordance with various embodiments of the present disclosure. In this regard, the null input of the Shapley-value-based determination corresponds to the prompt generated based on the base prompt instruction of the prompt template alone (e.g., the respective content quality metrics of the prompt generated based on the base prompt instruction of the prompt template alone). As each contribution of each of the selected prompt parameters are being measured with respect to the null input, the Shapley-value-based determination designates a zero value for each of the prompt parameter contribution metrics for each of the prompt parameters based on the null input. The Shapley-value-based determination utilizes the content quality metrics for each of the prompts generated based on combinations of prompt parameters to determine the contribution of each of the prompt parameters to the corresponding content quality metrics with respect to the null input.

In some embodiments, prompts are generated based on all possible combinations of the prompt parameters (e.g., for a smaller number of prompt parameters). In some embodiments, a sampling of combinations of the plurality of prompt parameters using a Shapley approximation is utilized (e.g., for a larger number of prompt parameters) to generate corresponding prompts. Any known sampling technique can be utilized. In some embodiments, a sampling method for Shapley approximation can be utilized by computing a Monte Carlo estimate for the Shapley value obtained by sampling from a uniform distribution of all permutations of the prompt parameters. In some embodiments, the sampling method utilizes a selection of a random subset of prompt parameters in the Shapley approximation.

Content quality metrics are determined for each of the prompts generated based on combinations of prompt parameters. In some embodiments, content quality metrics are determined for the prompts based on the corresponding prompt itself. In some embodiments, content quality metrics are determined for the prompts based on content generated by a language model based on the corresponding prompt.

In some embodiments, the content quality metrics correspond to stylistic dimensions. For example, each content quality metric may provide a score indicating whether content generated by a language model based on an input prompt and/or the input prompt itself meets a specific style. For example, a set of content quality metrics may be determined such as whether the content is in overall alignment with a business's branding guidelines, formal, corny, ambiguous, arrogant, aggressive, elitist, traditional, mundane, antagonistic, political, literal, tactical, emulating others, chasing trends, derivative, engaging, human, emotional, creative, thought provoking, directional, informational, conversational, straightforward, to the point, punchy, direct, really long, any other dimensions, and/or any combination thereof.

In this regard, a set of content quality metrics can be determined for each stylistic dimension (e.g., a score whether the content is in overall alignment with a business's branding guidelines, a score whether the content is formal, etc.) and/or each error measure for a prompt and/or generated content (e.g., such as content generated by a language model and/or an input prompt) to provide a score indicating how well the prompt and/or generated content adheres to each corresponding stylistic dimension and/or each error measure. In some embodiments, each content quality metric can be determined based on a brand alignment model that evaluates how well a given prompt and/or generated content aligns with the branding guidelines of a particular business. For example, given a text document of generated content, a brand alignment model determines a score (e.g., between 0 and 1) indicating how well the text document aligns with the overall style of the business and scores for each of the various stylistic dimensions defining the branding style, voice, tone, etc. of the business. In this regard, the brand alignment model provides insights into how well the text conforms to brand guidelines, while also identifying specific areas of improvement. In some embodiments, the brand alignment model utilizes a language model, such as an LLM, to determine a score for each stylistic dimension. In some embodiments, content quality can be determined with respect to any known error measure, such as accuracy, and/or other evaluation metric.

Prompt parameter contribution metrics corresponding to a contribution of each of the prompt parameters to the corresponding content quality metrics (e.g., determined for each of the prompts generated based on combinations of prompt parameters) are determined for each of the prompt parameters using a Shapley-value-based determination. For example, each prompt parameter can be scored with respect to each content quality metric using Shapley value computations, Shapley value approximation methods (e.g., Monte Carlo estimate), and/or any determination that utilizes Shapley value. In some embodiments, the prompt parameter contribution metrics correspond to lift percentages determined based on Shapley value computations or Shapley value approximation methods, and/or any determination that utilizes Shapley value. An example of prompt parameter contribution metrics with respect to a set of stylistic dimensions of content quality (e.g., overall alignment with a business's branding guidelines, human, straightforward, direct, traditional, and to the point) is shown in FIG. 3B.

A representation of the prompt parameter contribution metrics, such as the values of the prompt parameter contribution metrics or a graph of the prompt parameter contribution metrics, can be displayed to user via a user interface component. As shown in the example of FIG. 3B, a representation of the prompt parameter contribution metrics can be determined and displayed for each of the prompt parameters that are used to generate a prompt so that a user can assess each of the prompt parameters, in accordance with embodiments of the present disclosure.

In this regard, the prompt parameter contribution metrics provide granularity in assessment to provide insights enabling targeted prompt optimization based on the importance of its prompt parameters. Further, the approach is adaptable to any amount or type of prompt parameter. Even further, the approach is scalable across diverse enterprises. In some embodiments, the prompts and/or content generated based on prompts are continuously monitored (e.g., each time a business utilizes a prompt to generate marketing content) to update prompt parameter contribution metrics for each of the prompt parameters.

Advantageously, efficiencies of computing and network resources can be enhanced using implementations described herein. In particular, the automated use of Shapley values to evaluate the prompt generation parameters provides for a more efficient use of computing resources (e.g., higher throughput and reduced latency for a network, less packet generation costs, etc.) than conventional methods of manually performing random trial and error with the various prompt parameters where the programmer ultimately arrives at incomplete and subjective assessments as the programmer is unable to determine (1) the effect of various combinations of parameters and/or (2) objective metrics from manually performing a subjective assessment of the various prompt parameters. The technology described herein results in less operations over a computer network, which results in higher throughput, reduced latency and less packet generation costs as fewer packets are sent over a network. Therefore, the technology described herein conserves network resources.

### Overview of Exemplary Environments for Using Shapley Values to Evaluate Prompt Generation Parameters

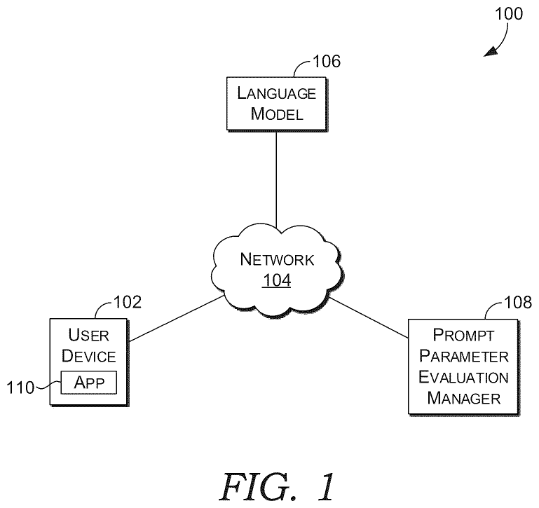

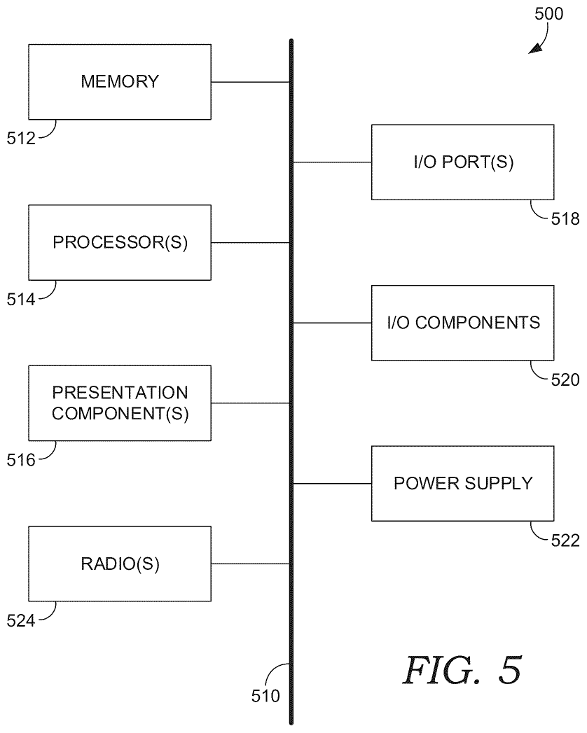

Turning to the figures, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 5.

It should be understood that operating environment 100 shown in FIG. 1 is an example of one suitable operating environment. Among other components not shown, operating environment 100 includes a user device 102, application 110, network 104, language model 106, and prompt parameter evaluation manager 108. Each of the components shown in FIG. 1 can be implemented via any type of computing device, such as one or more of computing device 500 described in connection to FIG. 5, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual or entity interested in assessing prompt parameter contribution metrics. For example, in some implementations, such devices are the type of computing device described in relation to FIG. 5. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

Application 110 operating on user device 102 can generally be any application capable of facilitating the inputting (e.g., and/or selection) of prompt parameters and/or presentation of prompt parameter contribution metrics (e.g., as determined by prompt parameter evaluation manager 108). In some implementations, the application 110 comprises a web application, which can run in a web browser, and could be hosted at least partially server-side (e.g., via language model 106 and/or prompt parameter evaluation manager 108). In addition, or instead, the application 110 can comprise a dedicated application. In some cases, the application 110 is integrated into the operating system (e.g., as a service).

User device 102 can be a client device on a client-side of operating environment 100, while language model 106 and/or prompt parameter evaluation manager 108 can be on a server-side of operating environment 100. Language model 106 and/or prompt parameter evaluation manager 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or prompt parameter evaluation manager 108 to remain as separate entities.

Application 110 operating on user device 102 can generally be any application capable of facilitating the exchange of information between the user device 102 and language model 106 and/or prompt parameter evaluation manager 108 in evaluating prompt parameters. In some implementations, the application 110 comprises a web application, which can run in a web browser, and could be hosted at least partially on the server-side of environment 100. In addition, or instead, the application 110 can comprise a dedicated application. In some cases, the application 110 is integrated into the operating system (e.g., as a service). It is therefore contemplated herein that “application” be interpreted broadly.

In accordance with embodiments herein, the application 110 facilitates the presentation of prompt parameter contribution metrics in an efficient and effective manner. In operation, as described herein, a user selects and/or inputs prompt parameters into application 110 via user device 102. In some embodiments, a user can select and/or input data in contextual input fields through application 110 via user device 102 to provide context to the language model 106 in generating the content. In some embodiments, a user can select prompt refinement tools to apply to the prompt through application 110 via user device 102.

A Shapley-value-based determination is used via prompt parameter evaluation manager 108 to determine combinations of the prompt parameters to be used to compute prompt parameter contribution metrics for each of the prompt parameters. Prompts are generated based on applying the combinations of the prompt parameters to a prompt template via prompt parameter evaluation manager 108. In this regard, the Shapley-value based determination is used via prompt parameter evaluation manager 108 to determine the number of combinations and/or the prompt parameters included in each combination. Examples of using the Shapley-value based determination are described in more detail with respect to FIG. 3A. In some embodiments, a sampling method for Shapley approximation can be utilized (e.g., by computing a Monte Carlo estimate for the Shapley value obtained by sampling from a uniform distribution of all permutations of the prompt parameters) via prompt parameter evaluation manager 108 in order to determine the combinations of the prompt parameters. Any known Shapley value approximation methods (e.g., any known approximation technique, such as a Monte Carlo estimate) can be used via prompt parameter evaluation manager 108 to determine the combinations of the prompt parameters.

In some embodiments, subsets of combinations of prompt parameters are applied to the prompt template in order to generate the plurality of prompts via prompt parameter evaluation manager 108. In some embodiments, a user can select which prompt parameters to generate prompt parameter contribution metrics via application 110.

In some embodiments, an instruction for a base prompt (e.g., a base prompt instruction), such as a designated task, is included via prompt parameter evaluation manager 108 in every combination to avoid evaluation of the base prompt. In some embodiments, the null input of the Shapley-value-based determination implemented via prompt parameter evaluation manager 108 corresponds to the prompt generated based on the base prompt instruction of the prompt template alone (e.g., the respective content quality metrics of the prompt generated based on the base prompt instruction of the prompt template alone). As each contribution of each of the selected prompt parameters are being measured via prompt parameter evaluation manager 108 with respect to the null input, the Shapley-value-based determination designates a zero value for each of the prompt parameter contribution metrics for each of the prompt parameters based on the null input. The Shapley-value-based determination implemented via prompt parameter evaluation manager 108 utilizes the content quality metrics for each of the prompts generated based on combinations of prompt parameters to determine the contribution of each of the prompt parameters to the corresponding content quality metrics with respect to the null input.

In some embodiments, prompts are generated based on all possible combinations of the prompt parameters (e.g., for a smaller number of prompt parameters) via prompt parameter evaluation manager 108. In some embodiments, a sampling of combinations of the plurality of prompt parameters using a Shapley approximation is utilized (e.g., for a larger number of prompt parameters) to generate corresponding prompts via prompt parameter evaluation manager 108. Any known sampling technique can be utilized via prompt parameter evaluation manager 108. In some embodiments, a sampling method for Shapley approximation can be utilized via prompt parameter evaluation manager 108 by computing a Monte Carlo estimate for the Shapley value obtained by sampling from a uniform distribution of all permutations of the prompt parameters. In some embodiments, the sampling method implemented via prompt parameter evaluation manager 108 utilizes a selection of a random subset of prompt parameters in the Shapley approximation.

Content quality metrics are determined for each of the prompts generated based on combinations of prompt parameters via prompt parameter evaluation manager 108. In some embodiments, content quality metrics are determined for the prompts via prompt parameter evaluation manager 108 based on the corresponding prompt itself. In some embodiments, content quality metrics are determined for the prompts via prompt parameter evaluation manager 108 based on content generated by language model 106 based on the corresponding prompt.

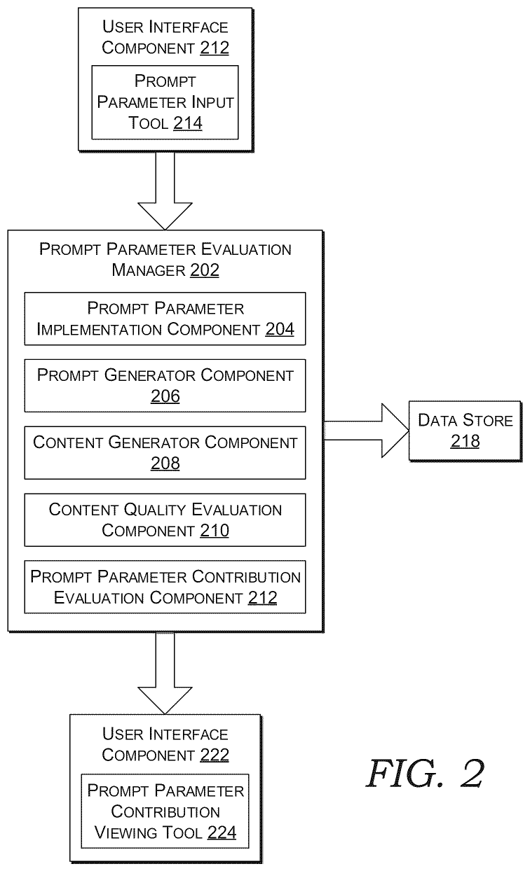

In some embodiments, the content quality metrics determined via prompt parameter evaluation manager 108 correspond to stylistic dimensions. In this regard, a set of content quality metrics can be determined via prompt parameter evaluation manager 108 for each stylistic dimension (e.g., a score whether the content is in overall alignment with a business's branding guidelines, a score whether the content is formal, etc.) and/or each error measure for a prompt and/or generated content (e.g., such as content generated by language model 106 and/or an input prompt) to provide a score indicating how well the prompt and/or generated content adheres to each corresponding stylistic dimension and/or each error measure. In some embodiments, each content quality metric can be determined based on a brand alignment model (e.g., content quality evaluation component 210 of FIG. 2) of prompt parameter evaluation manager 108 that evaluates how well a given prompt and/or generated content aligns with the branding guidelines of a particular business. In some embodiments, the brand alignment model (e.g., content quality evaluation component 210 of FIG. 2) of prompt parameter evaluation manager 108 utilizes a language model, such as language model 106, to determine a score for each stylistic dimension. In some embodiments, content quality can be determined by prompt parameter evaluation manager 108 with respect to any known error measure, such as accuracy, and/or other evaluation metric.

Prompt parameter contribution metrics corresponding to a contribution of each of the prompt parameters to the corresponding content quality metrics (e.g., determined for each of the prompts generated based on combinations of prompt parameters) are determined for each of the prompt parameters via prompt parameter evaluation manager 108 using a Shapley-value-based determination. For example, each prompt parameter can be scored via prompt parameter evaluation manager 108 with respect to each content quality metric using Shapley value computations, Shapley value approximation methods (e.g., Monte Carlo estimate), and/or any determination that utilizes Shapley value. In some embodiments, the prompt parameter contribution metrics determined via prompt parameter evaluation manager 108 correspond to lift percentages determined based on Shapley value computations or Shapley value approximation methods, and/or any determination that utilizes Shapley value. An example of prompt parameter contribution metrics with respect to a set of stylistic dimensions of content quality (e.g., overall alignment with a business's branding guidelines, human, straightforward, direct, traditional, and to the point) is shown in FIG. 3B.

A representation of the prompt parameter contribution metrics determined via prompt parameter evaluation manager 108, such as the values of the prompt parameter contribution metrics or a graph of the prompt parameter contribution metrics, can be displayed to user via a user interface component of application 110 via a display screen of user device 102. As shown in the example of FIG. 3B, a representation of the prompt parameter contribution metrics can be determined and displayed (e.g., via a user interface component of application 110 via a display screen of user device 102) for each of the prompt parameters that are used to generate a prompt so that a user can assess each of the prompt parameters.

In some embodiments, the prompts and/or content generated based on prompts are continuously monitored via prompt parameter evaluation manager 108 (e.g., each time a business utilizes a prompt to generate marketing content) to update prompt parameter contribution metrics for each of the prompt parameters.

At a high level, prompt parameter evaluation manager 108 performs various functionality to facilitate efficient and effective automated use of Shapley values to evaluate prompt generation parameters in order to provide prompt parameter contribution metrics to a user so that the user can utilize the prompt parameter contribution metrics to make decisions regarding the implementation of prompt parameters. Prompt parameter evaluation manager 108 can communicate with language model 106 in order to generate content to use Shapley values to evaluate prompt generation parameters in an efficient and effective manner. Prompt parameter evaluation manager 108 can communicate with application 110 in order for application 110 to display a representation of the prompt parameter contribution metrics via a display screen of the user device 102 (e.g., an example is shown in FIG. 3B).

Prompt parameter evaluation manager 108 and language model 106 can each be or include a server, including one or more processors, and one or more computer-readable media. The computer-readable media includes computer-readable instructions executable by the one or more processors. The instructions can optionally implement one or more components of prompt parameter evaluation manager 108 and language model 106, described in additional detail below with respect to prompt parameter evaluation manager 202 of FIG. 2.

For cloud-based implementations, the instructions on prompt parameter evaluation manager 108 and language model 106 can implement one or more components, and application 110 can be utilized by a user to interface with the functionality implemented on prompt parameter evaluation manager 108 and language model 106. In some cases, application 110 comprises a web browser. In other cases, prompt parameter evaluation manager 108 and/or language model 106 may not be required. For example, the components of prompt parameter evaluation manager 108 and/or language model 106 may be implemented completely on a user device, such as user device 102. In this case, prompt parameter evaluation manager 108, language model 106, and/or language model 116 may be embodied at least partially by the instructions corresponding to application 110.

Thus, it should be appreciated that prompt parameter evaluation manager 108 and language model 106 may be provided via multiple devices arranged in a distributed environment that collectively provide the functionality described herein. Additionally, other components not shown may also be included within the distributed environment. In addition, or instead, prompt parameter evaluation manager 108 and/or language model 106 can be integrated, at least partially, into a user device, such as user device 102. Furthermore, prompt parameter evaluation manager 108 and/or language model 106 may at least partially be embodied as a cloud computing service.

Referring to FIG. 2, aspects of an illustrative prompt parameter evaluation management system are shown, in accordance with various embodiments of the present disclosure. At a high level, the prompt parameter evaluation system can facilitate the efficient and effective use of Shapley values to evaluate prompt generation parameters in order provide prompt parameter contribution metrics to a user so that the user can utilize the prompt parameter contribution metrics to make decisions regarding the implementation of prompt parameters.

As shown in FIG. 2, prompt parameter evaluation manager 202 includes a prompt parameter implementation component 204, a prompt generator component 206, a content generator component 208, a content quality evaluation component 210, and a prompt parameter contribution evaluation component 212. Prompt parameter evaluation manager 202 can facilitate the automated use of Shapley values to evaluate prompt generation parameters in order to determine the contribution of prompt parameters to content quality metrics and store the prompt parameter contribution metrics in data store 218. Prompt parameter evaluation manager 202 receives prompt parameters input (e.g., and/or selected) via prompt parameter input tool 214 presented through user interface component 212. Prompt parameter evaluation manager 202 provides prompt parameter contribution viewing tool 224 for presentation of a representation of prompt parameter contribution metrics through user interface component 222. The prompt parameter evaluation manager 202 can communicate with the data store 218. The data store 218 is configured to store various types of information accessible by prompt parameter evaluation manager 202, or other server or component. The foregoing components of prompt parameter evaluation manager 202 can be implemented, for example, in operating environment 100 of FIG. 1. In particular, those components may be integrated into any suitable combination of user devices 102, language model 106, and/or prompt parameter evaluation manager 108. In this regard, user interface component 212 and/or user interface component 222 can be any type of user interface (e.g., a display screen/graphical user interface provided via the application 110 on user device 102).

In embodiments, data sources, user devices (such as user device 102 of FIG. 1, user interface component 212, and user interface component 222), and prompt parameter evaluation manager 202 can provide data to the data store 218 for storage, which may be retrieved or referenced by any such component. As such, the data store 218 can store computer instructions (e.g., software program instructions, routines, or services), data and/or models used in embodiments described herein, such as data and/or models related to prompt parameters, content quality metrics, prompt parameter contribution metrics, and/or the like. In some implementations, data store 218 can store information or data received or generated via the various components of prompt parameter evaluation manager 202 and provides the various components with access to that information or data, as needed. The information in data store 218 may be distributed in any suitable manner across one or more data stores for storage (which may be hosted externally).

The prompt parameter implementation component 204 is generally configured to implement prompt parameters, such as data in contextual input fields and/or prompt refinement tools. In embodiments, prompt parameter implementation component 204 can include rules, conditions, associations, models, algorithms, or the like to implement prompt parameters. Prompt parameter implementation component 204 may take on different forms depending on the mechanism used to implement prompt parameters. For example, prompt parameter implementation component 204 may comprise natural language processing techniques, a statistical model, fuzzy logic, neural network, finite state machine, support vector machine, logistic regression, clustering, or machine-learning techniques, similar statistical classification processes, or combinations of these to implement prompt parameters.

The prompt generator component 206 is generally configured to generate prompts (e.g., based on the prompt parameters implemented by prompt parameter implementation component 204 into a prompt template). In embodiments, prompt generator component 206 can include rules, conditions, associations, models, algorithms, or the like to generate prompts. Prompt generator component 206 may take on different forms depending on the mechanism used to generate prompts. For example, prompt generator component 206 may comprise natural language processing techniques, a statistical model, fuzzy logic, neural network, finite state machine, support vector machine, logistic regression, clustering, or machine-learning techniques, similar statistical classification processes, or combinations of these to generate prompts.

The content generator component 208 is generally configured to generate content based on prompts (e.g., content generator component 208 may include a language model and/or communicate a prompt generated by prompt generator 206 to a language model, such as language model 106 of FIG. 1). In embodiments, content generator component 208 can include rules, conditions, associations, models, algorithms, or the like to generate content. Content generator component 208 may take on different forms depending on the mechanism used to generate content. For example, content generator component 208 may comprise natural language processing techniques, a statistical model, fuzzy logic, neural network, finite state machine, support vector machine, logistic regression, clustering, or machine-learning techniques, similar statistical classification processes, or combinations of these to generate content.

The content quality evaluation component 210 is generally configured to determine content quality metrics for prompts (e.g., based on the prompt generated by prompt generator component 206 and/or the content generated by content generator component 208). In embodiments, content quality evaluation component 210 can include rules, conditions, associations, models, algorithms, or the like to determine content quality metrics for prompts. Content quality evaluation component 210 may take on different forms depending on the mechanism used to determine content quality metrics for prompts. For example, content quality evaluation component 210 may comprise natural language processing techniques, a statistical model, fuzzy logic, neural network, finite state machine, support vector machine, logistic regression, clustering, or machine-learning techniques, similar statistical classification processes, or combinations of these to determine content quality metrics for prompts.

The prompt parameter contribution evaluation component 212 is generally configured to determine prompt parameter contribution metrics corresponding to a contribution of each of the prompt parameters to the corresponding content quality metrics (e.g., as determined for prompts via content quality evaluation component 210). In embodiments, prompt parameter contribution evaluation component 212 can include rules, conditions, associations, models, algorithms, or the like to determine prompt parameter contribution metrics. Prompt parameter contribution evaluation component 212 may take on different forms depending on the mechanism used to determine prompt parameter contribution metrics. For example, prompt parameter contribution evaluation component 212 may comprise natural language processing techniques, a statistical model, fuzzy logic, neural network, finite state machine, support vector machine, logistic regression, clustering, or machine-learning techniques, similar statistical classification processes, or combinations of these to determine prompt parameter contribution metrics.

In embodiments, a user selects and/or inputs prompt parameters into prompt parameter input tool 214 of user interface component 212. In some embodiments, a user can select and/or input data in contextual input fields through prompt parameter input tool 214 of user interface component 212. In some embodiments, a user can select prompt refinement tools to apply to the prompt through prompt parameter input tool 214 of user interface component 212.

A Shapley-value-based determination by prompt parameter contribution evaluation component 212 is used to determine combinations of the prompt parameters to be implemented via prompt parameter implementation component 204 in order to compute prompt parameter contribution metrics for each of the prompt parameters. Prompts are generated by prompt generator component 206 based on applying the combinations of the prompt parameters to a prompt template via prompt parameter implementation component 204. In this regard, the Shapley-value based determination by prompt parameter contribution evaluation component 212 is used to determine the number of combinations and/or the prompt parameters included in each combination via prompt parameter implementation component 204. Examples of using the Shapley-value based determination are described in more detail with respect to FIG. 3A. In some embodiments, a sampling method for Shapley approximation can be utilized (e.g., by computing a Monte Carlo estimate for the Shapley value obtained by sampling from a uniform distribution of all permutations of the prompt parameters) by prompt parameter contribution evaluation component 212 in order to determine the combinations of the prompt parameters to be implemented via prompt parameter implementation component 204. Any known Shapley value approximation methods (e.g., any known approximation technique, such as a Monte Carlo estimate) can be used by prompt parameter contribution evaluation component 212 to determine the combinations of the prompt parameters to be implemented via prompt parameter implementation component 204.

In some embodiments, subsets of combinations of prompt parameters are applied to the prompt template via prompt parameter implementation component 204 in order to generate the plurality of prompts via prompt generator component 204. In some embodiments, a user can select which prompt parameters to generate prompt parameter contribution metrics via prompt parameter input tool 214.

In some embodiments, an instruction for a base prompt (e.g., a base prompt instruction), such as a designated task, is included via prompt generator component 204 in every combination to avoid evaluation of the base prompt via prompt parameter contribution evaluation component 212. In some embodiments, the null input of the Shapley-value-based determination implemented via prompt parameter contribution evaluation component 212 corresponds to the prompt generated via prompt generator component 204 based on the base prompt instruction of the prompt template alone (e.g., the respective content quality metrics of the prompt generated based on the base prompt instruction of the prompt template alone). As each contribution of each of the selected prompt parameters are being measured via prompt parameter contribution evaluation component 212 with respect to the null input, the Shapley-value-based determination designates a zero value for each of the prompt parameter contribution metrics for each of the prompt parameters based on the null input. The Shapley-value-based determination implemented via prompt parameter contribution evaluation component 212 utilizes the content quality metrics for each of the prompts generated via prompt generator component 204 based on combinations of prompt parameters to determine the contribution of each of the prompt parameters to the corresponding content quality metrics with respect to the null input.

In some embodiments, prompts are generated via prompt generator component 204 based on all possible combinations of the prompt parameters (e.g., for a smaller number of prompt parameters) applied via prompt parameter implementation component 204. In some embodiments, a sampling of combinations of the prompt parameters using a Shapley approximation is utilized (e.g., as determined via prompt parameter contribution evaluation component 212) to apply the sampling of combinations of prompt parameters via prompt parameter implementation component 204 to generate corresponding prompts via prompt generator component 204. Any known sampling technique can be utilized (e.g., as determined via prompt parameter contribution evaluation component 212). In some embodiments, a sampling method for Shapley approximation can be utilized (e.g., as determined via prompt parameter contribution evaluation component 212) by computing a Monte Carlo estimate for the Shapley value obtained by sampling from a uniform distribution of all permutations of the prompt parameters. In some embodiments, the sampling method implemented (e.g., as determined via prompt parameter contribution evaluation component 212) utilizes a selection of a random subset of prompt parameters in the Shapley approximation.

Content quality metrics are determined via content quality evaluation component 210 for each of the prompts generated based on combinations of prompt parameters via prompt generator component 204. In some embodiments, content quality metrics are determined for the prompts via content quality evaluation component 210 based on the corresponding prompt itself. In some embodiments, content quality metrics are determined for the prompts via content quality evaluation component 210 based on content generated by content generator component 208 based on the corresponding prompt. For example, content generator component 208 may generate content for each of the corresponding prompts by applying the prompts to a language model (e.g., language model 106 of FIG. 1).

In some embodiments, the content quality metrics determined via content quality evaluation component 210 correspond to stylistic dimensions. In this regard, a set of content quality metrics can be determined via content quality evaluation component 210 for each stylistic dimension (e.g., a score whether the content is in overall alignment with a business's branding guidelines, a score whether the content is formal, etc.) and/or each error measure for a prompt and/or generated content (e.g., such as content generated by content generator 208 and/or an input prompt generated by prompt generator 206) to provide a score indicating how well the prompt and/or generated content adheres to each corresponding stylistic dimension and/or each error measure. In some embodiments, each content quality metric can be determined based on a brand alignment model of content quality evaluation component 210 that evaluates how well a given prompt and/or generated content aligns with the branding guidelines of a particular business. In some embodiments, the brand alignment model of content quality evaluation component 210 utilizes a language model (e.g., language model 106 of FIG. 1) to determine a score for each stylistic dimension. In some embodiments, content quality can be determined via content quality evaluation component 210 with respect to any known error measure, such as accuracy, and/or other evaluation metric

Prompt parameter contribution metrics corresponding to a contribution of each of the prompt parameters to the corresponding content quality metrics (e.g., determined for each of the prompts generated based on combinations of prompt parameters) are determined for each of the prompt parameters via prompt parameter contribution evaluation component 212 using a Shapley-value-based determination. For example, each prompt parameter can be scored via prompt parameter contribution evaluation component 212 with respect to each content quality metric using Shapley value computations, Shapley value approximation methods (e.g., Monte Carlo estimate), and/or any determination that utilizes Shapley value. In some embodiments, the prompt parameter contribution metrics determined via prompt parameter contribution evaluation component 212 correspond to lift percentages determined based on Shapley value computations or Shapley value approximation methods, and/or any determination that utilizes Shapley value.

In some embodiments, the prompts generated by prompt generator component 206 and/or content generated by content generator component 208 based on prompts are continuously monitored (e.g., each time a business utilizes a prompt to generate marketing content) and scored by content quality evaluation component 210 to update prompt parameter contribution metrics for each of the prompt parameters via prompt parameter contribution evaluation component 212.

A representation of the prompt parameter contribution metrics determined via prompt parameter contribution evaluation component 212, such as the values of the prompt parameter contribution metrics or a graph of the prompt parameter contribution metrics, can be displayed through prompt parameter contribution viewing tool 224 of user interface component 222 (e.g., through application 110 via a display screen of the user device 102 of FIG. 1). As shown in the example of FIG. 3B, a representation of the prompt parameter contribution metrics can be determined and displayed (e.g., through prompt parameter contribution viewing tool 224 of user interface component 222) for each of the prompt parameters that are used to generate a prompt so that a user can assess each of the prompt parameters.

FIG. 3A provides an example diagram 300A of using Shapley values to evaluate prompt generation parameters, in accordance with embodiments of the present disclosure. As shown in FIG. 3A, at step 1 302, the user inputs a base prompt to designate the task. For example, the user inputs the task that the brand (e.g., business) is interested in generating content for. Further, the user inputs prompt parameters. In some embodiments, the user inputs data into contextual input fields, such as chunks of text that encapsulate various brand characteristics. Examples of data input into contextual input fields include brand summaries, campaign characteristics, and other relevant textual descriptors that can be appended directly to the base prompt. In some embodiments, any other text appendices pertinent to the task can be incorporated in order to ensure that the approach remains versatile, accommodating any relevant textual descriptor that enhances the prompt's context. In some embodiments, the user selects prompt refinement tools. For example, prompt refinement tools can allow for dynamic alterations to the existing prompt. Examples of prompt refinement tools include techniques such as acronym expansion, prompt compression, and rephrasing. In some embodiments, any text-to-text transformation can be implemented as a prompt refinement tool.

At step 304, with the selected prompt parameters, a master prompt template is generated that includes the base prompt. For example, the base prompt is not included in the determination of prompt parameter contribution metrics (e.g., the base prompt is included in every combination of prompt parameters that is utilized to determine content quality metrics). At step 306, the master template is augmented by placeholders for each of the contextual input fields. In this regard, the structured approach ensures the inclusion or exclusion of appendices becomes systematic and streamlined during the sampling process.

At step 308, to investigate the influence of each prompt parameter, a sampling method is used. For every iteration out of the predetermined k cycles at step 310, a random subset of prompt parameters is selected at step 312. Depending on the prompt parameter type, contextual input fields are either integrated into or excluded from the prompt and/or the resulting prompt undergoes the selected transformations of the corresponding prompt refinement tool. At step 314, after each sampling iteration, the resultant content from the constructed prompt is evaluated using a brand validator (e.g., content quality evaluation component 210 of FIG. 2). In some embodiments, an LLM with zero-shot capabilities is used as the brand validator. In this regard, the LLM quantifies (e.g., outputs a score between 0 and 1) for each generated content on a series of positive and negative traits that align with the brand guidelines (e.g., whether the content is in overall alignment with a business's branding guidelines, formal, corny, ambiguous, arrogant, aggressive, elitist, traditional, mundane, antagonistic, political, literal, tactical, emulating others, chasing trends, derivative, engaging, human, emotional, creative, thought provoking, directional, informational, conversational, straightforward, to the point, punchy, direct, really long, any other dimensions, and/or any combination thereof). In some embodiments, the LLM of the brand validator can be substituted with other models and/or human feedback mechanisms to quantify brand adherence.

At step 316, prompt parameter contribution metrics (e.g., the importance estimation) is determined. In this regard, at step 318, the prompt parameter contribution metrics (e.g., the importance estimation) are computed via Shapley values. In this regard, the Shapley value (e.g., cooperative game theory) is utilized to calculate the average contribution of each player (e.g., prompt parameter) when considering all possible coalitions in order to ensure that each prompt parameter's importance is assessed not only in isolation but also in conjunction with others.

Shapley value determines credit distribution in co-operative game theory to distribute the total returns to the players in a coalition. According to the Shapley value, the amount that player i gets given a coalitional game (f, N) is given by,

$${ϕ}_{i} ( f ) = {\sum }_{T ⊆ N ∖ \{ i \}} \vert T \vert ! \frac{( \vert N \vert - \vert T \vert - 1 ) ! ( f ( T ⋃ \{ i \} ) - f ( T ) )}{\vert E \vert !}$$

where N is the set consisting of all players and the sum extends over all subsets T of N not containing player i. The formula can be interpreted by imagining the coalition (f, N) being formed one actor at a time, with each actor demanding their contribution (f(T∪{i})−f(T)) as a fair compensation, and then for each actor, averaging this contribution over the possible different permutations in which the coalition can be formed.

Here, each prompt parameter corresponds to a player and the importance of each prompt parameter can be computed as follows:

$${S}_{i} = \frac{1}{\begin{matrix}number of \\ prompt parameters\end{matrix}} {\sum }_{\begin{matrix}samples including \\ prompt parameter i\end{matrix}} \frac{\begin{matrix}marginal contribution of \\ prompt parameter i\end{matrix}}{\begin{matrix}number of samples excluding \\ i of this size\end{matrix}}$$

In some embodiments, the importance assignment (e.g., prompt parameter contribution metric) is done based on the total number of prompt parameters and the feasibility of considering enough combinations. For example, in scenarios with a smaller set of prompt parameters, the Shapley value for each prompt parameter can be computed by considering all possible combinations (e.g., the exact Shapley value calculation), which offers the most accurate estimate. In another example, in scenarios with a larger number of prompt parameters (e.g., where enumerating all combinations via sampling becomes computationally prohibitive), approximation methods can be employed, such as by computing a Monte Carlo estimate for the Shapley value obtained by sampling from a uniform distribution of all permutations. In some embodiments, without loss of generality, this a different estimation technique (e.g., or a variation of the estimation technique) can be used with approximations that perform stratified sampling of the permutations for faster convergence.

Continuing with step 318, the lift percentage can be computed (e.g., for easier interpretation) for each prompt parameter (Lᵢ) compared to the baseline (B) when no prompt parameters are used as follows:

$${L}_{i} = ( \frac{{S}_{i}}{B} ) * 100$$

For example, in the context of brand-conformant content generation, the magnitude of the lift for each prompt parameter signifies the strength of the corresponding prompt parameter's impact on brand-conformant content generation. In this regard, a larger magnitude indicates a more pronounced effect. A positive sign denotes that the prompt parameter positively influences the content, making it more aligned with brand guidelines, while a negative sign suggests that the prompt parameter detracts from brand conformity, potentially making the content less consistent with the desired brand image. Thus, assessing both the magnitude and direction of the lift aids in understanding and prioritizing the prompt parameters for optimal content generation.

FIG. 3B provides an example diagram 300B of prompt parameter contribution metrics, in accordance with embodiments of the present disclosure. As shown in the example of FIG. 3B, prompt parameter contribution metrics can be determined for each of the prompt parameters that are used to generate a prompt so that a user can assess each of the prompt parameters, in accordance with embodiments of the present disclosure.

With respect to the example shown in FIG. 3B, a base prompt=“Write a persuasive email for {adobe_product}” can be input and sampled across different Adobe® products for the generation of content. An example prompt template can be provided as follows:

### Prompt Template

You are a helpful, respectful and honest assistant that generates marketing content that adheres to brand guidelines given below:
Brand summary: {brand_summary}
Base Instruction: “Write a persuasive email for {adobe_product}”

An example prompt parameter of a brand summary (e.g., brand_dna in FIG. 3B) can be provided as follows:
At Adobe, we believe that great design has the power to transform lives and transform businesses. That's why our brand is all about being helpful, respectful, and honest. We want our content to be engaging, human, emotional, creative, thought-provoking, and direct. We want our audience to feel inspired, empowered, and ready to take action.
That's why we avoid using overly formal or corny language, and we steer clear of ambiguity and elitism. We're not here to impress with fancy words or trendy jargon—we're here to help our audience achieve their goals. We're honest and straightforward in our communication, and we never sacrifice depth for the sake of brevity.
Our tone is conversational, but not careless. We're passionate about the work we do, but we're not arrogant or aggressive. We're here to provide value, not to chase trends or emulate others. We're not afraid to take risks and push boundaries, but we always do so with our audience in mind.
At Adobe, we believe that great design is a force for good. We believe that it can bring people together, challenge the status quo, and inspire positive change. And we believe that our brand should reflect that belief. So, when you read or hear something from Adobe, we want you to feel like you're part of something bigger than yourself—something that's changing the world for the better.

The following prompt parameter corresponding to prompt refinement tools can be selected: a prompt rephrasing tool (e.g., rephrase_prompt in FIG. 3B), a prompt compression tool (e.g., compress_prompt in FIG. 3B), an acronym expander tool (e.g., acronym_expansion in FIG. 3B), and a PII removal tool (e.g., pii_anonymization in FIG. 3B).

Parameter contribution metrics with respect to a set of stylistic dimensions of content quality (e.g., overall alignment with a business's branding guidelines, human, straightforward, direct, traditional, and to the point) can be determined. As can be understood from FIG. 3B, based on the overall lift score, which is 5.16 and positive in direction, the user can determine that the ‘brand_dna’ contextual input field (e.g., the brand summary) plays a pivotal role in ensuring content generation is in line with brand guidelines.

As can be further understood, the prompt compression tool and prompt rephrasing tool prompt parameters have minimal impact on adherence to brand guidelines based on the 0.27% and 0.47% effects on overall scores. In this regard, as these prompt parameters primarily aim to reduce token input into the LLM, the user can conclude that inclusion of the ‘prompt compression’ and ‘rephrase prompt’ prompt parameters for prompt optimization is likely beneficial for the reduced token cost.

As can be further understood, the acronym expander tool and the PII removal tool hamper the brand adherence. In this regard, the user can determine the potential causes and/or solutions. For example, with respect to the acronym expander tool, “AI” can refer to both “Artificial Intelligence” and “Adobe Illustrator,” which may indicate the need for a more advanced acronym expander tool that can understand context. As another example, with respect to the PII removal tool, the PII removal tool may occasionally misidentify and obscure essential prompt information, which may indicate the need for a more advanced acronym expander tool that can understand context and only obfuscate truly irrelevant details.

### Exemplary Implementation of Using Shapley Values to Evaluate Prompt Generation Parameters

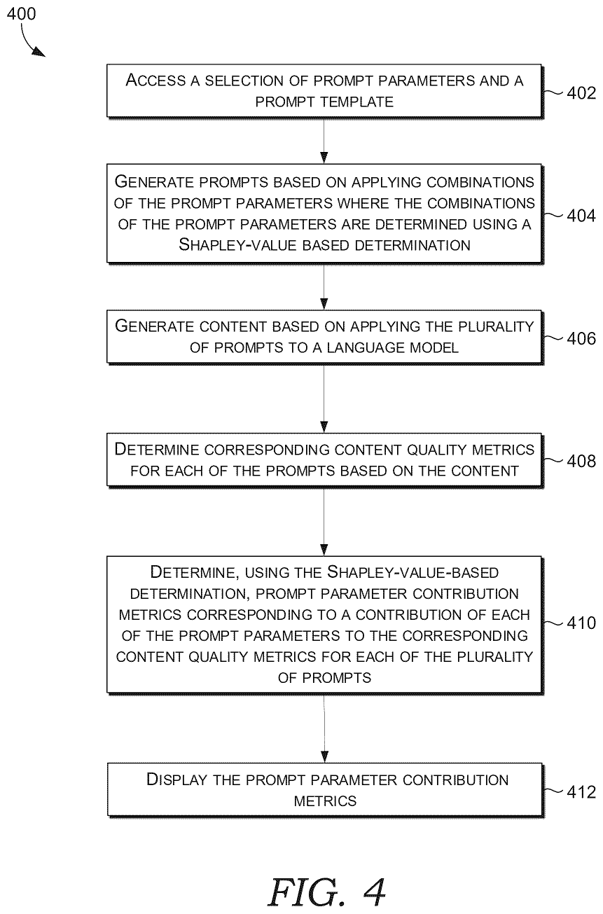

With reference now to FIG. 4, a flow diagram is provided showing exemplary method 400 related to using Shapley values to evaluate prompt generation parameters, in accordance with embodiments of the present technology. Each block of method 400 comprises a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few. The method flow of FIG. 4 are exemplary only and not intended to be limiting. As can be appreciated, in some embodiments, method flow 400 can be implemented, at least in part, to facilitate the automated use of Shapley values to evaluate prompt generation parameters in order provide prompt parameter contribution metrics to a user so that the user can utilize the prompt parameter contribution metrics to make decisions regarding the implementation of prompt parameters.

Turning to FIG. 4, a flow diagram is provided showing an embodiment of a method 400 for using Shapley values to evaluate prompt generation parameters in accordance with embodiments described herein. Such determination of prompt parameter contribution metrics can be used to efficiently and effectively provide prompt parameter contribution metrics to a user so that the user can utilize the prompt parameter contribution metrics to make decisions regarding the implementation of prompt parameters.

Initially, at block 402, a selection of prompt parameters and a prompt template are accessed. For example, a user selects and/or inputs prompt parameters. In some embodiments, a user can select and/or input data in contextual input fields to provide context to the language model in generating the content. For example, the contextual input fields can be designated fields in a prompt template. In some embodiments, a user can select prompt refinement tools to apply to the prompt.

At block 404, a Shapley-value-based determination is used to determine combinations of the prompt parameters to be used to compute prompt parameter contribution metrics for each of the prompt parameters and prompts are generated based on applying the combinations of the prompt parameters to a prompt template. In this regard, the Shapley-value based determination is used to determine the number of combinations and/or the prompt parameters included in each combination. Examples of using the Shapley-value based determination are described in more detail with respect to FIG. 3A. In some embodiments, a sampling method for Shapley approximation can be utilized (e.g., by computing a Monte Carlo estimate for the Shapley value obtained by sampling from a uniform distribution of all permutations of the prompt parameters) in order to determine the combinations of the prompt parameters. Any known Shapley value approximation methods (e.g., any known approximation technique, such as a Monte Carlo estimate) can be used to determine the combinations of the prompt parameters.

In some embodiments, subsets of combinations of prompt parameters are applied to the prompt template in order to generate the plurality of prompts. In some embodiments, a user can select which prompt parameters to generate prompt parameter contribution metrics. For example, the user may only want to view prompt parameter contribution metrics for prompt refinement tools. As another example, a base prompt may be included in every combination to avoid evaluation of the base prompt. In this regard, in some embodiments, a subset of the prompt parameters may be included in every combination in generating prompt.

In some embodiments, an instruction for a base prompt (e.g., a base prompt instruction), such as a designated task, is included in every combination to avoid evaluation of the base prompt. For example, a user designates a task of a base prompt, such as an instruction to introduce a particular product line. The user evaluates the contribution of each of the selected prompt parameters with respect to a prompt generated based on the base prompt instruction of the prompt template alone (e.g., without any additional prompt parameters that are being evaluated), in accordance with various embodiments of the present disclosure. In this regard, the null input of the Shapley-value-based determination corresponds to the prompt generated based on the base prompt instruction of the prompt template alone (e.g., the respective content quality metrics of the prompt generated based on the base prompt instruction of the prompt template alone). As each contribution of each of the selected prompt parameters are being measured with respect to the null input, the Shapley-value-based determination designates a zero value for each of the prompt parameter contribution metrics for each of the prompt parameters based on the null input. The Shapley-value-based determination utilizes the content quality metrics for each of the prompts generated based on combinations of prompt parameters to determine the contribution of each of the prompt parameters to the corresponding content quality metrics with respect to the null input.

In some embodiments, prompts are generated based on all possible combinations of the prompt parameters (e.g., for a smaller number of prompt parameters). In some embodiments, a sampling of combinations of the plurality of prompt parameters using a Shapley approximation is utilized (e.g., for a larger number of prompt parameters) to generate corresponding prompts. Any known sampling technique can be utilized. In some embodiments, a sampling method for Shapley approximation can be utilized by computing a Monte Carlo estimate for the Shapley value obtained by sampling from a uniform distribution of all permutations of the prompt parameters. In some embodiments, the sampling method utilizes a selection of a random subset of prompt parameters in the Shapley approximation.

At block 406, content is generated based on applying the plurality of prompts to a language model. At block 408, corresponding content quality metrics are determined for each of the prompts based on the content generated based on each of the prompts (e.g., as generated based on combinations of prompt parameters). In some embodiments, content quality metrics are determined for the prompts based on the corresponding prompt itself. In some embodiments, content quality metrics are determined for the prompts based on content generated by language model based on the corresponding prompt.

In some embodiments, the content quality metrics correspond to stylistic dimensions. For example, each content quality metric may provide a score indicating whether content generated by a language model based on an input prompt and/or the input prompt itself meets a specific style. In this regard, a set of content quality metrics can be determined for each stylistic dimension (e.g., a score whether the content is in overall alignment with a business's branding guidelines, a score whether the content is formal, etc.) and/or each error measure for a prompt and/or generated content (e.g., such as content generated by a language model and/or an input prompt) to provide a score indicating how well the prompt and/or generated content adheres to each corresponding stylistic dimension and/or each error measure. In some embodiments, each content quality metric can be determined based on a brand alignment model that evaluates how well a given prompt and/or generated content aligns with the branding guidelines of a particular business. For example, given a text document of generated content, a brand alignment model determines a score (e.g., between 0 and 1) indicating how well the text document aligns with the overall style of the business and scores for each of the various stylistic dimensions defining the branding style, voice, tone, etc. of the business. In some embodiments, the brand alignment model utilizes a language model, such as an LLM, to determine a score for each stylistic dimension. In some embodiments, content quality can be determined with respect to any known error measure, such as accuracy, and/or other evaluation metric.

At block 410, prompt parameter contribution metrics corresponding to a contribution of each of the prompt parameters to the corresponding content quality metrics are determined for each of the plurality of prompts (e.g., determined for each of the prompts generated based on combinations of prompt parameters) using the Shapley-value-based determination. For example, each prompt parameter can be scored with respect to each content quality metric using Shapley value computations, Shapley value approximation methods (e.g., Monte Carlo estimate), and/or any determination that utilizes Shapley value. In some embodiments, the prompt parameter contribution metrics correspond to lift percentages determined based on Shapley value computations or Shapley value approximation methods, and/or any determination that utilizes Shapley value.

At block 412, the prompt parameter contribution metric are displayed to a user. For example, a representation of the prompt parameter contribution metrics, such as the values of the prompt parameter contribution metrics or a graph of the prompt parameter contribution metrics, can be displayed to user. In some embodiments, the prompts and/or content generated based on prompts are continuously monitored (e.g., each time a business utilizes a prompt to generate marketing content) to update the prompt parameter contribution metrics for each of the prompt parameters.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 5 in particular, an exemplary operating environment for implementing aspects of the technology described herein is shown and designated generally as computing device 500. Computing device 500 is just one example of a suitable computing environment and is not intended to suggest any limitation as to the scope of use or functionality of the technology described herein. Neither should the computing device 500 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 5, computing device 500 includes a bus 510 that directly or indirectly couples the following devices: memory 512, one or more processors 514, one or more presentation components 516, input/output (I/O) ports 518, I/O components 520, an illustrative power supply 522, and a radio(s) 524. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 5 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 5 and refer to “computer” or “computing device.”

Computing device 500 typically includes a variety of computer-readable media. Computer-readable media can be any available media that can be accessed by computing device 500 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 512 includes computer storage media in the form of volatile and/or nonvolatile memory. The memory 512 may be removable, non-removable, or a combination thereof. Exemplary memory includes solid-state memory, hard drives, and optical-disc drives. Computing device 500 includes one or more processors 514 that read data from various entities such as bus 510, memory 512, or I/O components 520. Presentation component(s) 516 present data indications to a user or other device. Exemplary presentation components 516 include a display device, speaker, printing component, and vibrating component. I/O port(s) 518 allow computing device 500 to be logically coupled to other devices including I/O components 520, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 514 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 500. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as stereoscopic camera systems, infrared camera systems, RGB camera systems, and combinations of these, for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

A computing device may include radio(s) 524. The radio 524 transmits and receives radio communications. The computing device may be a wireless terminal adapted to receive communications and media over various wireless networks. Computing device 500 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

1. A computer-implemented method comprising:
accessing, via a prompt parameter implementation component, a plurality of prompt parameters;
generating, based on applying a plurality of combinations of one or more of the plurality of prompt parameters via a prompt generator component, a plurality of prompts;
determining, via a content quality evaluation component, a corresponding content quality metric for each of the plurality of prompts;
determining, via a prompt parameter contribution evaluation component using a Shapley-value-based determination, a plurality of prompt parameter contribution metrics corresponding to a contribution of each of the plurality of prompt parameters to the corresponding content quality metric for each of the plurality of prompts; and
causing display of a representation of at least a portion of the plurality of prompt parameter contribution metrics via a user interface component.

2. The computer-implemented method of claim 1, wherein at least one of the plurality of prompt parameters corresponds to a contextual input field.

3. The computer-implemented method of claim 1, wherein at least one of the plurality of prompt parameters corresponds to a prompt refinement tool.

4. The computer-implemented method of claim 1, wherein generating the plurality of prompts further comprises:
accessing a prompt template; and
applying the plurality of combinations of the one or more of the plurality of prompt parameters to the prompt template to generate the plurality of prompts.

5. The computer-implemented method of claim 1, wherein the plurality of combinations of the one or more of the plurality of prompt parameters corresponds to all combinations of a selection of the plurality of prompt parameters.

6. The computer-implemented method of claim 1, wherein the plurality of combinations of the one or more of the plurality of prompt parameters corresponds to a sampling of all combinations of a selection of the plurality of prompt parameters using a Shapley approximation.

7. The computer-implemented method of claim 1, wherein the corresponding content quality metric corresponds to a stylistic dimension.

8. The computer-implemented method of claim 1, wherein the corresponding content quality metric corresponds to an error measure.

9. The computer-implemented method of claim 1, further comprising:
updating the plurality of prompt parameter contribution metrics by monitoring subsequent prompts generated based on the plurality of prompt parameters.

10. The computer-implemented method of claim 1, wherein each of the plurality of prompt parameter contribution metrics corresponds to a lift percentage.

11. The computer-implemented method of claim 1, further comprising:
determining, via the content quality evaluation component, a corresponding set of content quality metrics for each of the plurality of prompts;
determining, via the prompt parameter contribution evaluation component using the Shapley-value-based determination, a plurality of sets of prompt parameter contribution metrics corresponding to a set of contributions of each of the plurality of prompt parameters to the corresponding set of content quality metrics for each of the plurality of prompts; and
causing display of a representation of at least a portion of the plurality of sets of prompt parameter contribution metrics via the user interface component.

12. A non-transitory computer-readable medium storing executable instructions, which when executed by a processing device, cause the processing device to perform operations comprising:
accessing, via a prompt parameter implementation component, a selection of a plurality of prompt parameters;
generating, based on applying a plurality of combinations of one or more of the plurality of prompt parameters via a prompt generator component, a plurality of prompts;
determining, via a content quality evaluation component, a corresponding set of content quality metrics for each of the plurality of prompts;
determining, via a prompt parameter contribution evaluation component using a Shapley-value-based determination, a plurality of sets of prompt parameter contribution metrics corresponding to a contribution of each of the plurality of prompt parameters to the corresponding set of content quality metrics for each of the plurality of prompts; and
causing display of a representation of at least a portion of the plurality of sets of prompt parameter contribution metrics via a user interface component.

13. The media of claim 12, wherein at least one of the plurality of prompt parameters corresponds to at least one of a contextual input field and a prompt refinement tool.

14. The media of claim 12, wherein generating the plurality of prompts further comprises:
accessing a prompt template; and
applying the plurality of combinations of the one or more of the plurality of prompt parameters to the prompt template to generate the plurality of prompts.

15. The media of claim 12, wherein the plurality of combinations of the one or more of the plurality of prompt parameters corresponds to at least one of all combinations of the selection of the plurality of prompt parameters and a sampling of all combinations of the selection of the plurality of prompt parameters designated for generation of prompt parameter contribution metrics using a Shapley approximation.

16. The media of claim 12, wherein each corresponding set of content quality metrics corresponds to at least one of stylistic dimension and an error measure.

17. The media of claim 12, further comprising:
updating the plurality of sets of prompt parameter contribution metrics by monitoring subsequent prompts generated based on the plurality of prompt parameters.

18. The media of claim 12, wherein each prompt parameter contribution metric of the plurality of sets of prompt parameter contribution metrics corresponds to a lift percentage.

19. A computing system comprising:
a processor; and
a non-transitory computer-readable medium having stored thereon instructions that when executed by the processor, cause the processor to perform operations including:
accessing, via a prompt parameter implementation component, a selection of a plurality of prompt parameters;
generating, based on applying a plurality of combinations of one or more of the plurality of prompt parameters via a prompt generator component, a plurality of prompts;
generating, based on applying the plurality of prompts to a language model via a content generator component, a plurality of content;
determining, via a content quality evaluation component, a corresponding set of content quality metrics for each of the plurality of prompts based on the plurality of content;
determining, via a prompt parameter contribution evaluation component using a Shapley-value-based determination, a plurality of sets of prompt parameter contribution metrics corresponding to a contribution of each of the plurality of prompt parameters to the corresponding set of content quality metrics for each of the plurality of prompts; and
causing display of a representation of at least a portion of the plurality of sets of prompt parameter contribution metrics via a user interface component.

20. The system of claim 19, wherein at least one of the plurality of prompt parameters corresponds to at least one of a contextual input field and a prompt refinement tool.
